(19) United States
(12) Patent Application Publication
(10) Pub. No.: US 2025/0068832 A1
(43) Pub. Date: Feb. 27, 2025

(54) MEDICAL DIGITAL WHITEBOARD SYSTEM

(71) Applicants: Alisha Shrum, Wakita, OK (US); Della Kay Shrum, Wakita, OK (US)

(72) Inventors: Alisha Shrum, Wakita, OK (US); Della Kay Shrum, Wakita, OK (US)

(21) Appl. No.: 18/236,845

(22) Filed: Aug. 22, 2023

(51) Int. Cl. G06F 40/174; G06F 3/041; G06F 3/16; G06K 7/10

(52) U.S. Cl. CPC G06F 40/174; G06F 3/0412; G06F 3/167; G06K 7/10

(57) ABSTRACT

A medical whiteboard system for displaying and updating patient health records includes an electronic whiteboard in communication with a computer network. The electronic whiteboard has a housing, a central processing unit and transceiver that are mounted within the housing, and a touch screen that is mounted on the housing. The touch screen displays a plurality of patient forms which provide information from an electronic health record. The touch screen can also receive physical or auditory input commands to adjust the display or edit the patient forms. The transceiver communicates with an external server where the electronic health records are stored, updating the health records across the entire computer network.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to digital white boards and more particularly pertains to a new digital white board for displaying and updating patient health records.

### (2) Description of Related Art Including Information Disclosed Under 37 CFR 1.97 and 1.98

The prior art relates to digital white boards. Some disclosures teach multifunctional electronic white boards with memory modules and touch screen display modules. Some disclosures teach electronic white boards that are operably coupled with radio-frequency identification scanners that read card number and status information processed by the electronic white board's processor. However, there is a need in the art for an electronic white board that can be installed in patient rooms and operating rooms to display information from an electronic health record. There is also a need in the art for an electronic white board that can connect with a centralized hospital computer network to update the electronic health record from any of the electronic white boards. Finally, there is a need for an electronic white board that can operate by voice command, for example enabling medical professionals to make handsfree updates to the patient's electronic health record while in an operating room or other sterile environment.

### BRIEF SUMMARY OF THE INVENTION

An embodiment of the disclosure meets the needs presented above by generally comprising an electronic whiteboard in communication with a computer network. The electronic whiteboard has a housing, a central processing unit and transceiver that are mounted within the housing, and a touch screen that is mounted on the housing. The touch screen displays a plurality of patient forms which provide information from an electronic health record. The touch screen can also receive physical or auditory input commands to adjust the display or edit the patient forms. The transceiver communicates with an external server where the electronic health records are stored, updating the health records across the entire computer network.

There has thus been outlined, rather broadly, the more important features of the disclosure in order that the detailed description thereof that follows may be better understood, and in order that the present contribution to the art may be better appreciated. There are additional features of the disclosure that will be described hereinafter, and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front isometric view of a medical whiteboard system according to an embodiment of the disclosure.

FIG. 2 is a front view of an embodiment of the disclosure.

FIG. 3 is a sample form view of an embodiment of the disclosure.

FIG. 4 is an in-use view of an embodiment of the disclosure.

FIG. 5 is a block diagram view of an embodiment of the disclosure.

### DETAILED DESCRIPTION OF THE INVENTION

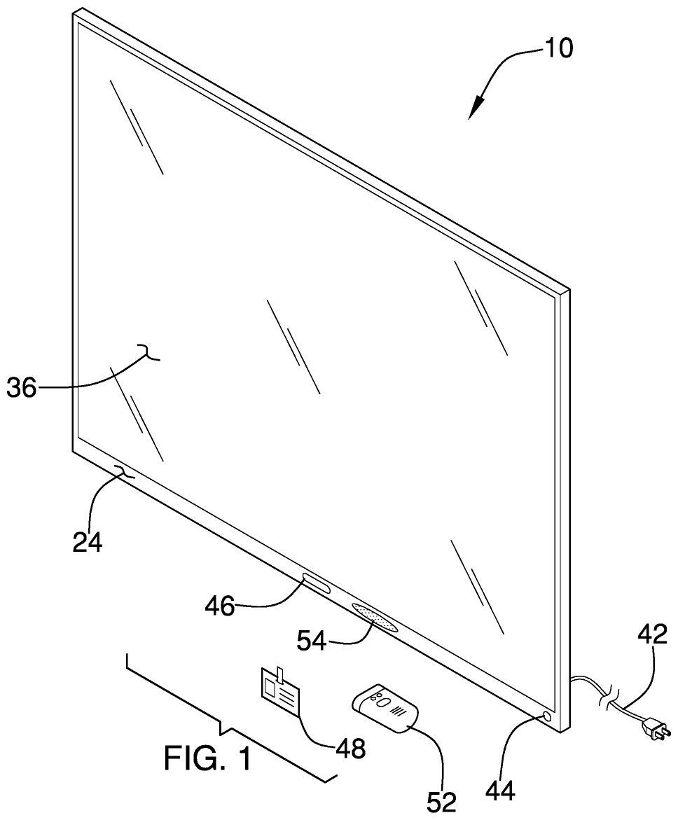

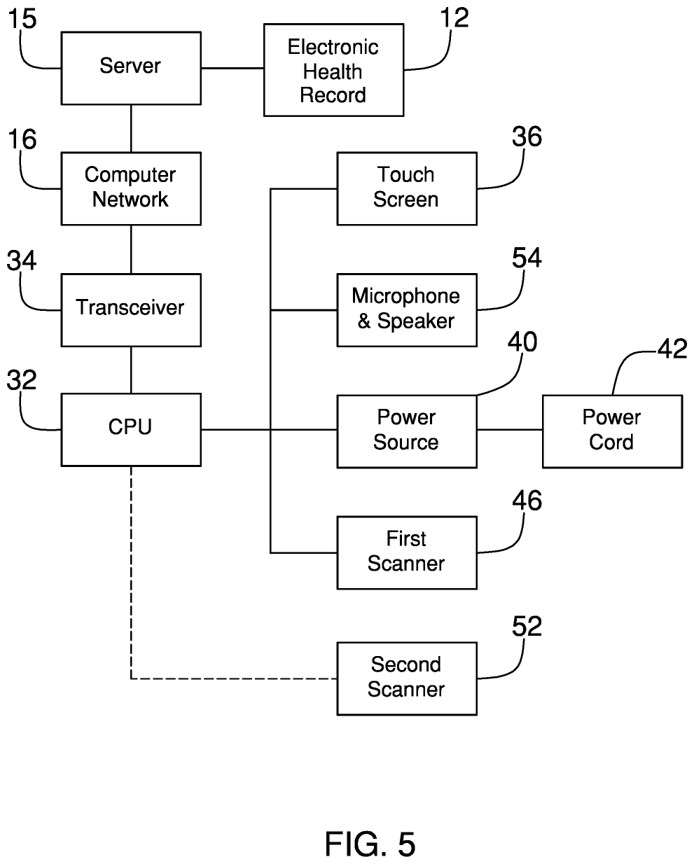

With reference now to the drawings, and in particular to FIGS. 1 through 5 thereof, a new digital white board embodying the principles and concepts of an embodiment of the disclosure and generally designated by the reference numeral 10 will be described.

As best illustrated in FIGS. 1 through 5, the medical whiteboard system 10 generally comprises a digital whiteboard device 20 that is configured to edit and display an electronic health record 12 of a patient 14. In some embodiments, the digital whiteboard device 20 may have a generally rectangular shape having a diagonal length ranging from 30 inches to 45 inches. For example, the digital whiteboard device may have a diagonal length of 36 inches. In other embodiments, the digital whiteboard device 20 may have smaller dimensions so that the device 20 is more portable.

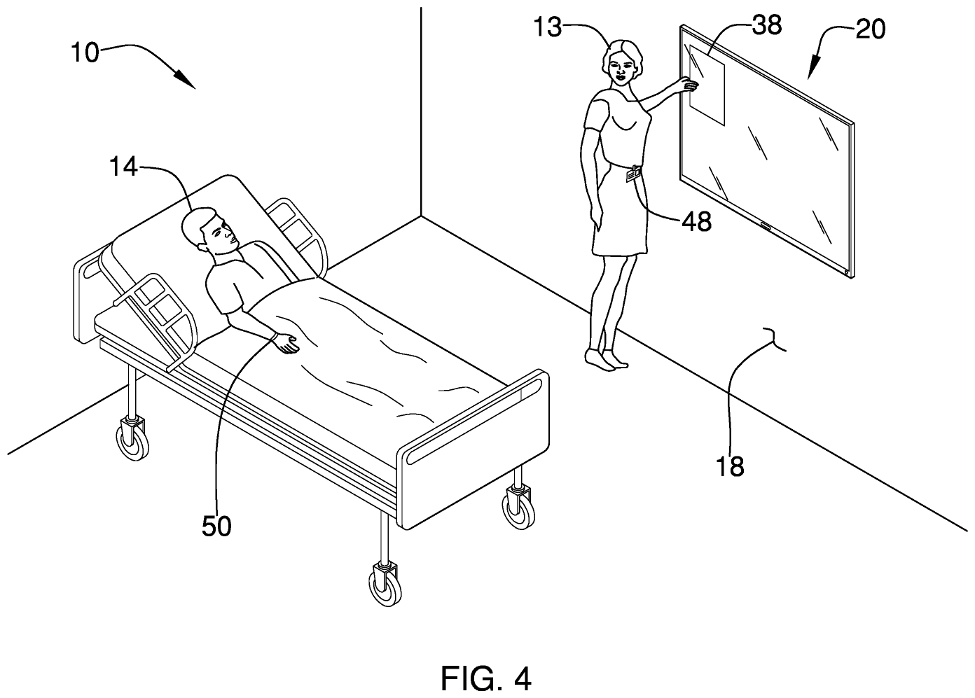

The digital whiteboard device 20 comprises a housing 22 having a front side 24, a back side 26 and a perimeter wall 28 extending between the front side 24 and the back side 26 to define an interior space 30 between the front side 24 and the back side 26. The digital whiteboard device 20 may be mounted to any wall 18 in a hospital or other medical facility by coupling the back side 26 to the wall 18. When mounted to the wall 18, as shown in FIG. 4, the front side 24 faces outwardly so that the front side 24 is visible to the patient 14 and the user 13.

A central processing unit 32 is mounted to the housing 22 within the interior space 30. A transceiver 34 is electronically coupled to the central processing unit 32. The transceiver 34 is wirelessly in communication with a computer network 16. A power supply 40 is electronically coupled to the central processing unit 32. For example, the power supply 40 may comprise a battery positioned within the interior space 30 and electronically coupled to a power cord 42 that is configured for insertion into a wall outlet. The power cord 42 may extend outwardly from the back side 26 so that it can easily reach the outlet when the digital whiteboard device 20 is mounted to the wall 18. A power button 44 may also be placed on the housing 22, for example on a lower corner of the front side 24. The power button 44 may be placed in any convenient location on the digital whiteboard device 20. The power button 44 is coupled to the power supply 40 and the central processing unit 32. The power button is actuatable to turn the central processing unit 32 on or off.

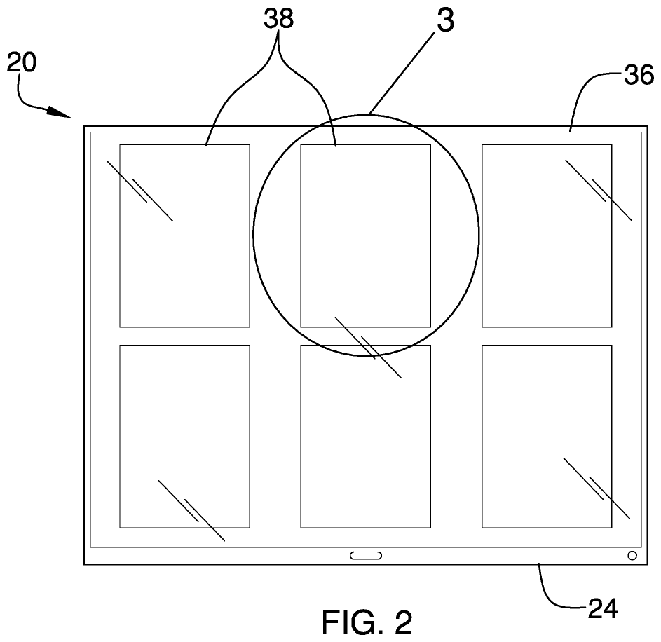

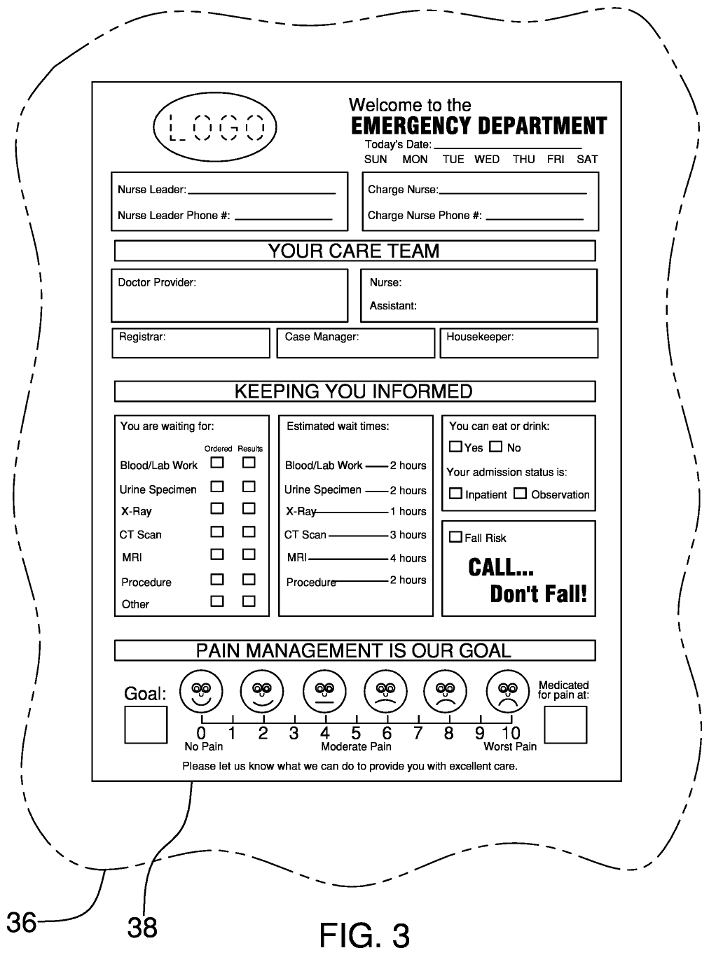

A touch screen 36 is mounted to the front side 24. The touch screen 36 is electronically coupled with the central processing unit 32. A plurality of patient forms 38 is displayed on the touch screen 36. The plurality of patient forms 38 is configured to provide information from the electronic health record 12. In the example provided in FIG. 3, particular ones of the plurality of patient forms 38 could be designed for particular departments of the medical facility, such as the emergency department. The plurality of patient forms 38 could provide information about the care team assigned to the patient and information about the care status of the patient. The plurality of patient forms 38 could keep the patient informed about their care, for example by showing dietary restrictions or upcoming tests, scans, or procedures which have been ordered by the care team. In the example provided in FIG. 3, the plurality of patient forms 38 could also show estimated wait times for scans or laboratory results. In other embodiments, the plurality of patient forms 38 provide hospital information such as maps, contact information, and available services. The plurality of patient forms 38 may also include additional patient information, such as preferred languages, names of family members, and acceptable times for visitors to arrive. The plurality of patient forms 38 may be used to keep the medical staff, care team, hospital staff, and patient informed and up to date about the patient's status and concerns. The touch screen 36 may display a one of the plurality of patient forms 38, as shown in FIG. 4. In alternative embodiments, the touch screen 36 may simultaneously display various ones of the plurality of patient forms 38, as depicted in FIG. 2.

The touch screen 36 is configured to receive a physical input that edits at least a one of the plurality of patient forms 38. The physical input may be a direct physical touch from the patient 14 or the user 13. The physical input may also be through an intermediary device, such as an electronic pen or stylus. In other embodiments, the physical input may be provided through an external computing device, such as a computer or tablet that is also in communication with the computer network 16. An external server 15 is in communication with the computer network 16. The external server 15 is configured to store the plurality of patient forms 38 and the electronic health record 12. The computer network 16 is configured to keep the plurality of patient forms 38 updated across the entire network, so that the most up-to-date version is available on any digital whiteboard device 20 connected to the computer network 16. That way, the user 13 can access a particular portion of the electronic health record 12 from any digital whiteboard device 20, whether the device 20 is installed in the patient's room, an operating room, or any other area of the medical facility. The digital whiteboard device 20 can therefore supplement, or potentially replace, traditional charting techniques which need to be manually updated across different versions.

A first scanner 46 may be positioned on the front side 24. The first scanner 46 is electronically coupled with the central processing unit 32. The first scanner 46 is configured to read an identification signal that is transmitted from at least one of a badge 48 or a wrist band 50. A second scanner 52 may also be electronically coupled with the central processing unit 32. In the example shown in FIG. 1, the second scanner 52 may be external to the digital whiteboard device 20 and wirelessly in communication with the central processing unit 32. In such embodiments, the second scanner 52 can be used to read an identification signal at a distance from the digital whiteboard device 20.

The signal may be any machine-readable code or signal that can provide identifying information to the central processing unit 32. For example, the signal may comprise radio-frequency identification, near-field communication, short-range wireless technology, or quick response code. For example, the user 13 may scan their identification badge 48 to access an electronic health record 12 that is associated with that user 13. In another example, the user 13 may scan the wrist band 50 of the patient 14 to access an electronic health record 12 of that patient.

The digital whiteboard device 20 may also include a microphone 54 that is electronically coupled with the central processing unit 32. As shown in FIG. 1, the microphone 54 may be mounted to the front side 24. However, the microphone 54 may be positioned anywhere on the digital whiteboard device 20. The microphone 54 is configured to receive an audio input, thereby enabling handsfree adjustment of the display on the touch screen 36. The microphone 54 may also enable handsfree editing of the plurality of patient forms 38. The microphone 54 may further include a speaker so that audio may be emitted from the digital whiteboard device 20. For example, some embodiments may include a camera positioned on the front side 24. With the speaker and the camera, the digital whiteboard device 20 could be used for video calls or telehealth visits with the medical team assigned to the patient 14. The patient 14 could also use the digital whiteboard device for video calls with family members, for example because the patient 14 needs to be quarantined or because the family members are unable to visit the patient 14 in person.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the elements is present, unless the context clearly requires that there be only one of the elements.

1. A digital whiteboard device being configured to edit and display an electronic health record of a patient, the digital whiteboard device comprising:
a housing having a front side, a back side and a perimeter wall extending between the front side and the back side to define an interior space between the front side and the back side;
a central processing unit being mounted to the housing and within the interior space;
a transceiver being electronically coupled to the central processing unit, the transceiver being wirelessly in communication with a computer network;
a touch screen being mounted to the front side, the touch screen being electronically coupled with the central processing unit;
a plurality of patient forms being displayed on the touch screen, the plurality of patient forms being configured to provide information from the electronic health record;
the touch screen being configured to receive a physical input, wherein the physical input edits at least a one of the plurality of patient forms;
an external server being in communication with the computer network, the external server storing the plurality of patient forms and the electronic health record;
a first scanner being mounted on the housing, the first scanner being electronically coupled with the central processing unit, the central processing unit being programmed to permit display of the patient forms upon the first scanner reading an identification signal transmitted from at least one of a badge or a wrist band;
a second scanner being electronically coupled with the central processing unit, the second scanner being wirelessly in communication with the central processing unit, the central processing unit being programmed to permit display of the patient forms upon the second scanner reading an identification code transmitted from at least one of the badge or the wrist band; and
a power supply being electronically coupled to the central processing unit.

2. (canceled)

3. (canceled)

4. (canceled)

5. (canceled)

6. (canceled)

7. The digital whiteboard device of claim 1, power supply further comprising a battery positioned within the interior space.

8. The digital whiteboard device of claim 1, further comprising a power cord extending outwardly from the back side, the power cord being electronically coupled to the power supply.

9. The digital whiteboard device of claim 8, wherein the power cord is configured for insertion into a wall outlet.

10. The digital whiteboard device of claim 1, further comprising a power button being electronically coupled to the power supply and the central processing unit, the power button being actuatable to turn the central processing unit on or off.

11. The digital whiteboard device of claim 10, wherein the power button is mounted on the front side.

12. The digital whiteboard device of claim 1, further comprising a microphone being electronically coupled with the central processing unit.

13. The digital whiteboard device of claim 12, wherein the microphone is configured to receive an audio input, the audio input enabling handsfree adjustment or editing of the plurality of patient forms.

14. A digital whiteboard system being configured to edit and display an electronic health record of a patient, the digital whiteboard system comprising:
a computer network having a server, the server storing the electronic health record;
a housing having a front side, a back side and a perimeter wall extending between the front side and the back side to define an interior space between the front side and the back side;
a central processing unit being mounted to the housing and within the interior space;
a transceiver being electronically coupled to the central processing unit, the transceiver being wirelessly in communication with the computer network;
a touch screen being mounted to the front side, the touch screen being electronically coupled with the central processing unit;
a plurality of patient forms being displayed on the touch screen, the plurality of patient forms being configured to provide information from the electronic health record;
the touch screen display being configured to receive a physical input, wherein the physical input edits at least a one of the plurality of patient forms;
a first scanner being positioned on the front side of the housing, the first scanner being electronically coupled with the central processing unit, the central processing unit being programmed to permit display of the patient forms upon the first scanner reading an identification signal being transmitted from at least one of a badge or a wrist band;
a second scanner being electronically coupled with the central processing unit, the second scanner being wirelessly in communication with the central processing unit, the central processing unit being programmed to permit display of the patient forms upon the second scanner reading an identification code being transmitted from at least one of the badge or the wrist band;
a power supply being electronically coupled to the central processing unit, the power supply comprising a battery positioned within the interior space;
a power cord extending outwardly from the back side, the power cord being electronically coupled to the power supply, the power cord being configured for insertion into a wall outlet;
a power button being electronically coupled to the power supply and the central processing unit, the power button being actuatable to turn the central processing unit on or off, the power button being mounted on the front side; and
a microphone being electronically coupled with the central processing unit, the microphone being configured to receive an audio input, the audio input enabling handsfree adjustment or editing of the plurality of patient forms.
